(19) United States
(12) Patent Application Publication
(10) Pub. No.: US 2006/0066650 A1
(43) Pub. Date: Mar. 30, 2006

(54) Method and apparatus for printing using a plurality of basic colorants and at least one high fidelity colorant

(76) Inventors: Xuan-Chao Huang, Lexington, KY (US); Brant Dennis Nystrom, Lexington, KY (US); Richard L. Reel, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/955,540

(22) Filed: Sep. 29, 2004

(51) Int. Cl. B41J 2/195

(52) U.S. Cl. 347/7

(57) ABSTRACT

A method of printing using a plurality of basic colorants and at least one high fidelity colorant includes obtaining system variables that impact high fidelity color printing; and printing with an optimized usage of the plurality of basic colorants and the at least one high fidelity colorant based on a colorant level, wherein a reduced output of the at least one high fidelity colorant will occur if an average colorant level of the at least one high fidelity colorant is lower than an average colorant level of the plurality of basic colorants.

### BACKGROUND OF THE INVENTION

1. Field of the Invention

The present invention relates to printing, and, more particularly, to a method and apparatus for printing using a plurality of basic colorants and at least one high fidelity colorant.

2. Description of the Related Art

Traditionally, within the printing industry, three or four colorants have been used in various printers. A three-colorant printer uses cyan, magenta and yellow basic colorants (CMY). A four-colorant printer includes a basic black colorant with the basic CMY system to achieve deeper shadow tones. Black is designated “K” and therefore the CMY system becomes a CMYK system with the addition of black colorant. Such three and four colorant printers produce red (or orange), green, or blue color by overprinting two of the colorants on top of one another. The gamut available to a printer by overprinting the colorants is restricted by the properties of the colorants and may not meet the requirements of high performance printing, i.e., the more colorful printing that requires a color gamut greater than that provided by traditional three or four colorant printers. Recently, printing systems with additional colorant such as red, green, and blue (RGB), or orange and green (OG), or other colors, referred to as high fidelity colorants, have been developed for high fidelity (hi-fi) color printing. These printers, such as CMYKOG or CMYKRGB printers, are often referred as high fidelity printers, and provide a greater color gamut for richer color output than traditional printers.

Although the high fidelity printers are capable of producing certain colors more accurately or with more richness than traditional CMYK printers, high fidelity printers also incur higher printing costs due to the cost associated with high fidelity colorants. However, certain images may not require the full color gamut capability of high fidelity printers, and hence, some or all of the high fidelity colorants may not be necessary for reproducing such images. Thus, printing such images with a high fidelity printer may incur unnecessary costs by using high fidelity colorants where CMY or CMYK colorants suffice.

What is needed in the art is an improved method and apparatus for printing using a plurality of basic colorants and at least one high fidelity colorant.

### SUMMARY OF THE INVENTION

The present invention provides an improved method and apparatus for printing using a plurality of basic colorants and at least one high fidelity colorant.

The invention, in one form thereof, relates to a method of printing using a plurality of basic colorants and at least one high fidelity colorant. The method includes obtaining system variables that impact high fidelity color printing; and printing with an optimized usage of the plurality of basic colorants and the at least one high fidelity colorant based on a colorant level, wherein a reduced output of the at least one high fidelity colorant will occur if an average colorant level of the at least one high fidelity colorant is lower than an average colorant level of the plurality of basic colorants.

The invention, in another form thereof, relates to an imaging apparatus for printing using a plurality of basic colorants in a first printing cartridge and at least one high fidelity colorant in a second printing cartridge. The imaging apparatus includes a print engine configured to mount the first printing cartridge and the second printing cartridge and configured to print on a substrate using the first printing cartridge and the second printing cartridge. A controller is communicatively coupled to the print engine. The controller executes instructions to obtain system variables that impact high fidelity color printing, and to drive the print engine to print with an optimized usage of the plurality of basic colorants and the at least one high fidelity colorant based on a colorant level. A reduced output of the at least one high fidelity colorant will occur if an average colorant level of the at least one high fidelity colorant is lower than an average colorant level of the plurality of basic colorants.

An advantage of the present invention is that high fidelity printing can be performed with a reduced usage of high fidelity colorants.

Another advantage is that the colorant usage can be balanced in a high fidelity printing system while retaining the more colorful output of the high fidelity printing system.

Yet another advantage is that the life of a high fidelity printing cartridge may be extended.

Still another advantage is that the cost of high fidelity printing may be reduced.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system that employs an imaging apparatus in accordance with the present invention.

FIG. 2 is a diagrammatic depiction of a colorspace converter accessing a color conversion lookup table in accordance with the embodiment of FIG. 1.

FIGS. 3A and 3B are a flowchart that generally depicts an embodiment of a method in accordance with the present invention.

FIG. 4 is a colorant usage table in accordance with the embodiment of FIGS. 3A and 3B.

FIG. 5 is a graphical representation of a reduced usage of a high fidelity colorant in accordance with the embodiment of FIGS. 3A and 3B.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

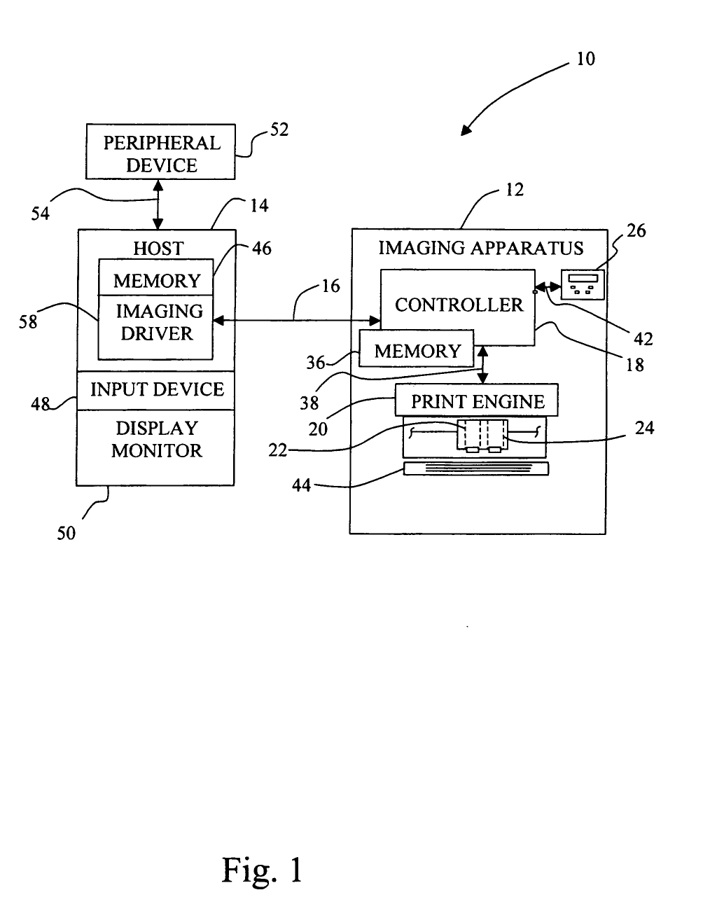

Referring now to the drawings, and particularly to FIG. 1, there is shown a diagrammatic depiction of an imaging system 10 embodying the present invention. Imaging system 10 includes an imaging apparatus 12 and a host 14. Imaging apparatus 12 communicates with host 14 via a communications link 16.

Imaging apparatus 12 may be, for example, an ink jet printer and/or copier, an electrophotographic printer and/or copier that is used in conjunction with a scanner, or an all-in-one (AIO) unit that includes a printer, a scanner, and possibly a fax unit. In the present embodiment, imaging apparatus 12 includes a controller 18, a print engine 20, a basic printing cartridge 22, a high fidelity printing cartridge 24, and a user interface 26.

Controller 18 includes a processor unit and associated memory 36, and may be formed as one or more Application Specific Integrated Circuits (ASIC). Controller 18 is a printer controller, but may alternatively be a scanner controller, or combined printer and scanner controller. Although controller 18 is depicted in imaging apparatus 12, alternatively, it is contemplated that all or a portion of controller 18 may reside in host 14. Controller 18 is communicatively coupled to print engine 20 via a communications link 38, and to user interface 26 via a communications link 42. Controller 18 serves to process print data and to operate print engine 20 to perform printing.

In the context of the examples for imaging apparatus 12 given above, print engine 20 may be, for example, an ink jet print engine or a color electrophotographic print engine. Print engine 20 is configured to mount one or more of basic printing cartridge 22 and one or more of high fidelity printing cartridge 24 and to print on a substrate 44 using basic printing cartridge 22 and high fidelity printing cartridge 24. Substrate 44 is a print medium, and may be one of many types of print media, such as a sheet of plain paper, fabric, photo paper, coated ink jet paper, greeting card stock, transparency stock for use with overhead projectors, iron-on transfer material for use in transferring an image to an article of clothing, and back-lit film for use in creating advertisement displays and the like. As an ink jet print engine, print engine 20 operates basic printing cartridge 22 and high fidelity printing cartridge 24 to eject ink droplets onto substrate 44 in order to reproduce text or images, etc. As an electrophotographic print engine, print engine 20 causes one or more of basic printing cartridge 22 and one or more of high fidelity printing cartridge 24 to deposit toner onto substrate 44, which is then fused to substrate 44 by a fuser (not shown).

Host 14 may be, for example, a personal computer, including memory 46, an input device 48, such as a keyboard, and a display monitor 50. A peripheral device 52, such as a digital camera, is coupled to host 14 via a communication link 54. Host 14 further includes a processor, input/output (I/O) interfaces, memory, such as RAM, ROM, NVRAM, and at least one mass data storage device, such as a hard drive, a CD-ROM and/or a DVD unit.

During operation, host 14 includes in its memory a software program including program instructions that function as an imaging driver 58, e.g., printer/scanner driver software, for imaging apparatus 12. Imaging driver 58 is in communication with controller 18 of imaging apparatus 12 via communications link 16. Imaging driver 58 facilitates communication between imaging apparatus 12 and host 14, and may provide formatted print data to imaging apparatus 12, and more particularly, to print engine 20. Although imaging driver 58 is disclosed as residing in memory 46 of host 14, it is contemplated that, alternatively, all or a portion of imaging driver 58 may be located in controller 18 of imaging apparatus 12, for example, in memory 36 or a firmware component of controller 18.

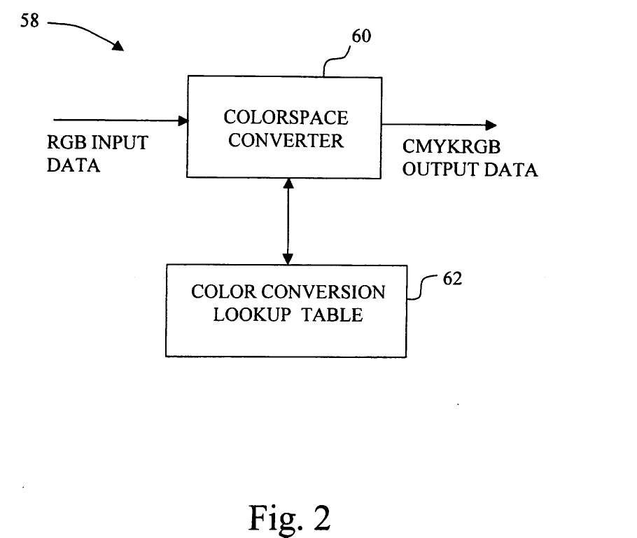

Referring now to FIG. 2, imaging driver 58 includes a colorspace converter 60. Although described herein as residing in imaging driver 58, colorspace converter 60 may be in the form of firmware or software, and may reside in either imaging driver 58 or controller 18. Alternatively, some portions of colorspace converter 60 may reside in imaging driver 58, while other portions reside in controller 18.

Coupled to colorspace converter 60 is a color conversion lookup table 62. Colorspace converter 60 converts color signals from an RGB colorspace output by display monitor 50 to an output colorspace using color conversion lookup table 62. For example, the output colorspace may be CMYKOG, CMYKRGB, or any colorspace that includes basic CMYK in conjunction with high fidelity colors. Color conversion lookup table 62 is a multidimensional lookup table having at least three dimensions, and includes RGB input values and the corresponding high fidelity output values. Color conversion lookup table 62 may also include other data, such as spectral data.

Color conversion lookup table 62 may also be in the form of groups of polynomial functions capable of providing the same multidimensional output as if in the form of a lookup table. As shown in FIG. 2, for example, colorspace converter 60 converts input RBG color data into CMYKRGB output data, using color conversion lookup table 62.

Imaging apparatus 12, as an ink jet printer, is configured to print using a plurality of basic colorants in basic printing cartridge 22 and a plurality high fidelity colorants in high fidelity printing cartridge 24.

Although the present embodiment employs the use of a plurality of high-fidelity colorants in high fidelity printing cartridge 24, it is contemplated that alternatively, high fidelity printing cartridge 24 may contain a single high fidelity colorant, or that imaging apparatus 12 may employ more than one basic printing cartridge 22, each of which contains a one or more different basic colorant of the plurality of basic colorants, and similarly, that imaging apparatus 12 may employ more than one high fidelity printing cartridge, each of which contains one or more different high fidelity colorant of the plurality of high fidelity colorants.

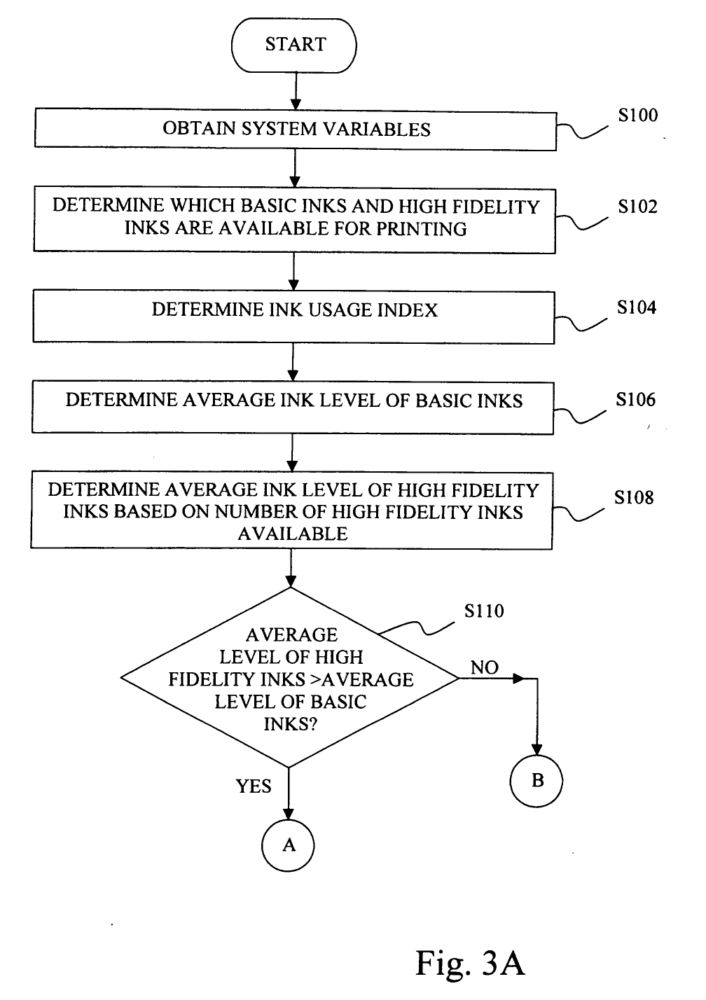

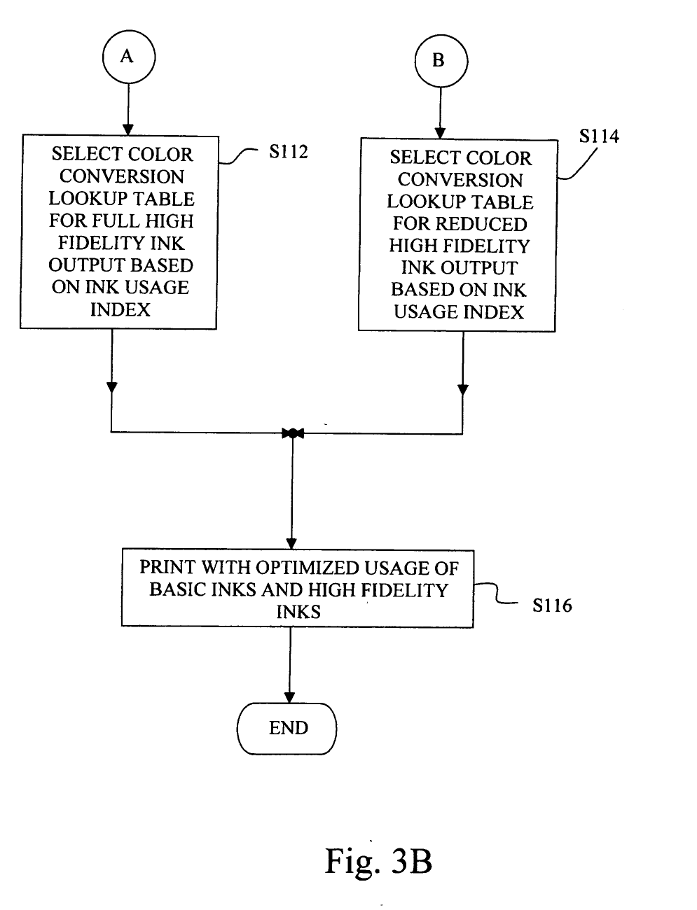

Referring now to FIGS. 3A and 3B, a method of performing variable high fidelity printing using a plurality of basic colorants and a plurality of high fidelity colorants in accordance with the present invention is depicted.

With reference to FIG. 3A, at step S100, controller 18 executes instructions to obtain system variables that impact high fidelity color printing.

The operation of imaging apparatus 12 is based on system variables, each of which has an impact on printing. For example, the system variables may include printing quality, colorant level, and user preference. The system variables may be entered via user interface 26, and stored in memory 36, and hence, are always known by imaging apparatus 12 for any given printing job.

Printing quality pertains to the quality of the output desired by the user, which may or may not call for the use of the high fidelity colorants in high fidelity printing cartridge 24. For example, low quality printings (e.g., draft mode and plain paper normal quality) may only need the traditional CMYK printing in order to provide printed output acceptable to the user, whereas high quality printings (e.g., photo printing) may need high fidelity printing.

Ink level pertains to the level of colorant for each color in or of basic printing cartridge 22 and high fidelity printing cartridge 24. Colorant level is the remaining amount of colorant in the cartridge, and is determined in a manner known in the art, for example, by subtracting the amount of colorant used for printing from a known amount of colorant in the cartridge. The amount of colorant used is determined, for example, by controller 18 keeping track of the number of the number of pixels, or dots printed.

User preference pertains to whether the user selects basic or high fidelity printing, based on a special requirement. For example, the user may desire to reproduce an image that is not capable of accurate reproduction using basic colorants only, such as in a wildlife photo with red and green colors exceed the chromaticity capable of being rendered with the basic colorants.

At step S102, controller 18 executes instructions to determine which basic colorants and high fidelity colorants are available for printing based on the system variables.

For example, if the user selects a draft print mode, high fidelity colorants will not be used, and hence the basic colorants available for printing are: cyan, magenta, yellow, and black (CMYK); and the high fidelity colorants available for printing will be zero. Similarly, if the user merely wishes to print a business memo, the basic colorants available for printing is black (true black colorant), and there will be no high fidelity colorants available for printing. Alternatively, the memo may be printed using composite black, also referred to as process black, which is a combination of CMY colorants in approximately equal proportion, wherein the basic colorants available for printing is CMY, and there are no high fidelity colorants available for printing. As another alternative, the memo may be printed using both composite black and true black (CMYK), wherein CMYK colorants are available for printing.

The user may also select high fidelity printing for printing various images or documents, for example, photo, a brochure, a PowerPoint ®presentation, a greeting card, or any image for which a rich color output is desired. If the user selects photo quality printing, for example, and each of the RGB colorants are available, the basic colorants available for printing will be CMYK, and the high fidelity colorants available for printing will red, green, and blue (RGB). On the other hand, if the user selects photo quality printing, but one of the high fidelity colorants in high fidelity printing cartridge 24 has been used up, for example, the remaining colorant level of red colorant in high fidelity printing cartridge 24 is zero, the high fidelity colorants available for printing will be green and blue, i.e., the green colorant and blue colorant is remaining in high fidelity printing cartridge 24.

At step S104, controller 18 executes instructions to determine a colorant usage index 64 based on the high fidelity colorants. Colorant usage index 64 is determined based on the high fidelity colorants available for printing, and is used in order to determine color conversion lookup table 62. While the present embodiment of colorant usage table 66 and colorant usage index 64 are based on the usage of high fidelity colorants and an assumption of usage of all of the plurality of basic colorants, it will be understood by those skilled in the art that colorant usage table 66 and colorant usage index 64 are merely illustrative of the one embodiment of the present invention, and that an actual implementation may include a colorant usage index 64 and a corresponding colorant usage table 66 that are based on all the colorants available for printing, i.e., both the basic and high fidelity colorants available for printing.

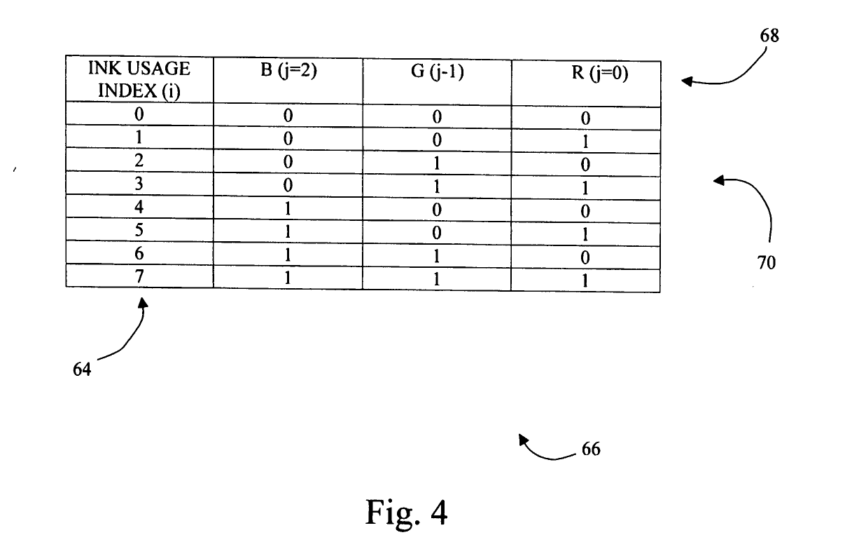

Referring now to FIG. 4, a colorant usage table 66 is depicted, which illustrates the various combinations of high fidelity colorant usage. Colorant usage table 66 illustrates a color identifier 68 and a colorant usage value 70 that are used in determining colorant usage index 64. As implied by its name, color identifier 68 identifies the high fidelity colorants that may be used by imaging apparatus 12. In the present embodiment, color identifier identifies blue colorant with a “2”, green colorant with a “1”, and red colorant with a “0”. A colorant usage value 70 of “0” indicates that the particular high fidelity colorant pertaining to an associated color identifier 68 is not available for printing, and a colorant usage value of “1” indicates that the particular high fidelity colorant is available for printing.

Defining n as the total number of the high fidelity colorants that may be printed using imaging apparatus 12, the possible number of usages of the high fidelity colorants is 2ⁿ. In the present embodiment, n=3, since there are three high fidelity colorants; red, green, and blue. Colorant usage table 66 illustrates the 8 combinations of high fidelity colorant usage, which have a colorant usage index 64, from 0 to 7, wherein a colorant usage index 64 of 0 indicates that no high fidelity colorants are available for printing, and a colorant usage index 64 of 7 indicates that all the high fidelity colorants are available for printing. A colorant usage index of 7 yields high fidelity printing, whereas a colorant usage value from 1 to 6 yields partial high fidelity printing, and a colorant usage index of 0 is indicates basic color printing.

The colorant usage index is computed by:

$$i = {\sum }_{j = 0}^{n - 1} {2}^{j} {U}_{j} \qquad Equation ( 1 )$$

where

i is the colorant usage index;

j is the high fidelity color identifier (j=0, 1, 2 for R, G, B, respectively);

n is the total possible number of high fidelity colorants used by imaging apparatus 12; and

Uⱼ=usage of j^{th} high fidelity colorant, equaling 1 if used, 0 if not used.

Referring again to FIG. 3A, at step S106, controller 18 executes instructions to determine the average colorant level of basic colorants remaining in basic printing cartridge 22. In the present embodiment, the average colorant level is an arithmetic average. Alternatively, however, it is contemplated that a weighted average may be employed, for example, based on a usage history of the basic colorants, a colorant dot size associated with a particular color of colorant, for example, where imaging apparatus 12 prints using multiple dot sizes, or based on the initial quantities of the particular colorants supplied with basic printing cartridge 22.

At step S108, controller 18 executes instructions to determine the average level of the high fidelity colorants available for printing that is remaining in high fidelity printing cartridge 24, not including the high fidelity colorants having a colorant usage value of 0. Hence, the average level of the high fidelity colorants is the average level of the high fidelity colorants available for printing. As with the basic colorants, in the present embodiment, the average colorant level is an arithmetic average. Alternatively, however, it is contemplated that a weighted average may be employed, for example, as set forth above with respect to basic printing cartridge 22.

Depending on what is printed by imaging apparatus 12, the high fidelity colorants may be used-up more quickly than the basic colorants. For example, a red (or orange) colorant may be used up more quickly if more skin tone images are printed, whereas a green colorant may be used up more quickly if more images depicting outdoor scenes having a lot of trees and grass are printed.

The advantage of using high fidelity colorants is that a more colorful output may be achieved for colors with hues closer to the hues of the high fidelity colorants. For example, the printing of grasses and trees will be enhanced using the green colorant, since the secondary green color made from the basic cyan and yellow colorants is not as chromatic as that of the green colorant. However, the less chromatic colors, i.e., those printed colors lower on the chroma scale, can be accurately reproduced using only the basic colorants.

If the average level of the high fidelity colorants is higher than that of the basic colorants, imaging apparatus 12 will employ a full usage, i.e., a full output, of the high fidelity colorants, as set forth below.

At step S110, controller 18 executes instructions to determine whether the average colorant level of the high fidelity colorants available for printing is greater than average colorant level of the basic colorants available for printing. If so, process flow proceeds to step S112. Otherwise, process flow proceeds to step S114. The decision of step S110 is used in optimizing the usage of the high fidelity colorants, for example, to minimize the use of the high fidelity colorants when the level of high fidelity colorants remaining in high fidelity printing cartridge 24 is diminished as compared to the basic colorants. This preserves the possibility of printing future images using high fidelity colorants without replacing high fidelity printing cartridge 24, and extends the life of high fidelity printing cartridge 24, thus reducing the cost associated with high fidelity printing.

The full output of high fidelity colorants is set at 100% across the chroma range, whereas the reduced output employs less high fidelity colorant in the low chroma region and then increases it to 100% at and beyond the maximum chroma achievable using the basic colorants alone. The term, “full output”, indicates that the output of each high fidelity colorant available for printing is the amount of colorant that would normally be used to print the desired image. The reduced output of the additional colorants is employed by imaging apparatus 12 if the average level of the additional colorants is lower than that of the basic colorants, and balances the colorant usage while retaining the advantages of high fidelity printing.

Thus, the optimized usage of the high fidelity colorants is a full output of the high fidelity colorants available for printing if the average colorant level of the high fidelity colorants available for printing is higher than the average colorant level of the basic colorants available for printing, as indicated in step S112, but is otherwise a reduced output of the high fidelity colorants available for printing, as more fully described in step S114.

At step S112, controller 18 executes instructions to determine color conversion lookup table 62 based on providing a full output of each high fidelity colorant available for printing.

The determination of color conversion lookup table 62 based on colorant usage index 64 is described as follows.

For each colorant usage index 64i, there exists a corresponding color conversion lookup table stored in memory accessible to imaging apparatus 12, for example, memory 36 of controller 18, or stored as part of imaging driver 58. For example, a CMYK color conversion lookup table is associated with a colorant usage index of 0, whereas a CMYKRGB color conversion lookup table is associated with a colorant usage index of 7. As a further example, a CMYKRB color conversion lookup table is associated with a colorant usage index of 5, which may be deduced from colorant usage table 66, since the green colorant is not available for printing, as indicated by a colorant usage value 70 of 0. Thus, printing will be performed using color conversion lookup table 62 as being determined based on the remaining amount of each high fidelity colorant in high fidelity printing cartridge 24.

Each color conversion lookup table includes entries pertaining to each colorant in CMYKRGB imaging apparatus 12, although output values for high fidelity colorants are set to zero for those high fidelity colorants that are not available for printing. Each color conversion table provides as output a digital count value for each of the colorants that imaging apparatus 12 is capable of printing.

Color conversion lookup table 62, being based on colorant usage index 64 may be given by:
dcs=ƒ(i,Rₚ,Gₚ,Bₚ) (2)
where dcs represents the printer colorant digital counts, i is the colorant usage index computed with Equation 1, Rₚ, Gₚ, Bₚ is red, green, blue input color value, respectively, of an input image pixel, and ƒ denotes the function relationship that can be implemented as a lookup table or a group of polynomial functions, and is representative of color conversion lookup table 62 as based on colorant usage index 64.

At step S114, controller 18 executes instructions to employ a reduced output of the high fidelity colorants available for printing if the average colorant level of the high fidelity colorants is lower than the average colorant level of the basic colorants, and to thus determine color conversion lookup table 62 based on providing the reduced output of each high fidelity colorant available for printing. Color conversion lookup table 62 is thus selected based on colorant usage index 64.

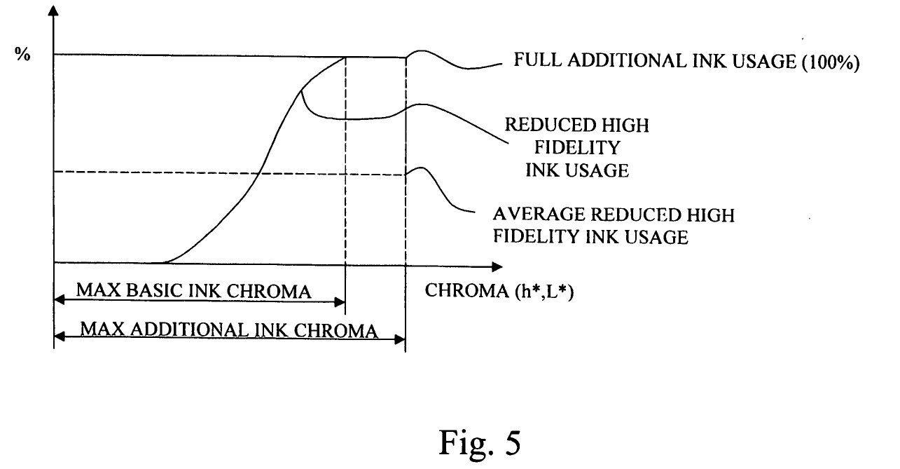

Referring now to FIG. 5, the reduced output of plurality of high fidelity colorants available for printing varies with a chromaticity of the image, and more particularly, the reduced output of the plurality of high fidelity colorants available for printing varies from a full output of the plurality of high fidelity colorants available for printing to a zero output of the plurality of high fidelity colorants available for printing with a decreasing chromaticity of the image.

In the embodiment depicted, the reduced output of plurality of high fidelity colorants available for printing is a reduced output of more than one high fidelity colorant of the plurality of high fidelity colorants available for printing. For example, if red, green, and blue colorants are available for printing, in the present embodiment, the output of each color of high fidelity colorant is reduced. However, it will be understood that using the concepts provided by the present invention and disclosed herein, only two of the three colorants available for printing may have reduced output, while the third may employ full output, for example, where a portion or portions of the image have a hue predominantly the same as that of the third color and larger chroma than the basic inks. Similarly, the reduced output of the plurality of high fidelity colorants available for printing may alternatively be a reduced output of one high fidelity colorant of the plurality of high fidelity colorants available for printing, with full output for the other colorants, for example, should a portion or portions of the image have hues and chroma requiring a full output of those two of the three high fidelity colorants.

Referring again to FIG. 3B, at step S116, controller 18 executes instructions to drive print engine 20 to print with an optimized usage of the plurality of basic colorants available for printing and the high fidelity colorants available for printing, based on the average colorant levels, as set forth above in steps S110 to S114.

While this invention has been described with respect to exemplary embodiments, it will be recognized that the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of printing using a plurality of basic colorants and at least one high fidelity colorant, comprising:
obtaining system variables that impact high fidelity color printing; and
printing with an optimized usage of said plurality of basic colorants and said at least one high fidelity colorant based on a colorant level,
wherein a reduced output of said at least one high fidelity colorant will occur if an average colorant level of said at least one high fidelity colorant is lower than an average colorant level of said plurality of basic colorants.

2. The method of claim 1, wherein said reduced output of at least one high fidelity colorant varies with a chromaticity of said image.

3. The method of claim 2, wherein said reduced output of said at least one high fidelity colorant varies from a full output of said at least one high fidelity colorant to a zero output of said at least one high fidelity colorant with a decreasing chromaticity of said image.

4. The method of claim 1, wherein said reduced output of said at least one high fidelity colorant is a reduced output of one high fidelity colorant.

5. The method of claim 4, wherein said reduced output of said at least one high fidelity colorant is a reduced output of more than one high fidelity colorant.

6. The method of claim 1, wherein said at least one high fidelity colorant is a plurality of high fidelity colorants, further comprising determining which of said plurality of basic colorants and said plurality of high fidelity colorants are available for printing based on said system variables, wherein said reduced output of said at least one high fidelity colorant is a reduced output of said plurality of high fidelity colorants available for printing.

7. The method of claim 6, wherein said reduced output of said plurality of high fidelity colorants available for printing varies with a chromaticity of said image.

8. The method of claim 7, wherein said reduced output of said plurality of high fidelity colorants available for printing varies from a full output of said plurality of high fidelity colorants available for printing to a zero output of said plurality of high fidelity colorants available for printing with a decreasing chromaticity of said image.

9. The method of claim 6, wherein said reduced output of said plurality of high fidelity colorants available for printing is a reduced output of one high fidelity colorant of said plurality of high fidelity colorants available for printing.

10. The method of claim 9, wherein said reduced output of said plurality of high fidelity colorants available for printing is a reduced output of more than one high fidelity colorant of said plurality of high fidelity colorants available for printing.

11. The method of claim 6, wherein said optimized usage is a full output of said plurality of high fidelity colorants available for printing if said average colorant level of said plurality of high fidelity colorants available for printing is higher than said average colorant level of said plurality of basic colorants available for printing.

12. The method of claim 11, wherein said printing is performed using a color conversion lookup table, and wherein said color conversion lookup table is determined based on said plurality of high fidelity colorants available for printing.

13. An imaging apparatus for printing using a plurality of basic colorants in a first printing cartridge and at least one high fidelity colorant in a second printing cartridge, comprising:
a print engine configured to mount said first printing cartridge and said second printing cartridge and configured to print on a substrate using said first printing cartridge and said second printing cartridge; and
a controller communicatively coupled to said print engine, said controller executing instructions to:
obtain system variables that impact high fidelity color printing; and
drive said print engine to print with an optimized usage of said plurality of basic colorants and said at least one high fidelity colorant based on a colorant level,
wherein a reduced output of said at least one high fidelity colorant will occur if an average colorant level of said at least one high fidelity colorant is lower than an average colorant level of said plurality of basic colorants.

14. The imaging apparatus of claim 13, wherein said reduced output of at least one high fidelity colorant varies with a chromaticity of said image.

15. The imaging apparatus of claim 13, wherein said reduced output of said at least one high fidelity colorant varies from a full output of said at least one high fidelity colorant to a zero output of said at least one high fidelity colorant with a decreasing chromaticity of said image.

16. The imaging apparatus of claim 13, wherein said reduced output of said at least one high fidelity colorant is a reduced output of one high fidelity colorant.

17. The imaging apparatus of claim 16, wherein said reduced output of said at least one high fidelity colorant is a reduced output of more than one high fidelity colorant.

18. The imaging apparatus of claim 13, wherein said at least one high fidelity colorant is a plurality of high fidelity colorants, further comprising determining which of said plurality of basic colorants and said plurality of high fidelity colorants are available for printing based on said system variables, wherein said reduced output of said at least one high fidelity colorant is a reduced output of said plurality of high fidelity colorants available for printing.

19. The imaging apparatus of claim 18, wherein said reduced output of said plurality of high fidelity colorants available for printing varies with a chromaticity of said image.

20. The imaging apparatus of claim 19, wherein said reduced output of said plurality of high fidelity colorants available for printing varies from a full output of said plurality of high fidelity colorants available for printing to a zero output of said plurality of high fidelity colorants available for printing with a decreasing chromaticity of said image.

21. The imaging apparatus of claim 18, wherein said reduced output of said plurality of high fidelity colorants available for printing is a reduced output of one high fidelity colorant of said plurality of high fidelity colorants available for printing.

22. The imaging apparatus of claim 21, wherein said reduced output of said plurality of high fidelity colorants available for printing is a reduced output of more than one high fidelity colorant of said plurality of high fidelity colorants available for printing.

23. The imaging apparatus of claim 18, wherein said optimized usage is a full output of said plurality of high fidelity colorants available for printing if said average colorant level of said plurality of high fidelity colorants available for printing is higher than said average colorant level of said plurality of basic colorants available for printing.

24. The imaging apparatus of claim 23, wherein said printing is performed using a color conversion lookup table, and wherein said color conversion lookup table is determined based on said plurality of high fidelity colorants available for printing.
